(19) United States
(12) Patent Application Publication
(10) Pub. No.: US 2014/0101616 A1
(43) Pub. Date: Apr. 10, 2014

(54) ELECTRONIC DEVICE AND METHOD FOR CREATING VIRTUAL FOLDER AND MANAGING STORED APPLICATIONS

(71) Applicant: Samsung Electronics Co., Ltd., Gyeonggi-do (KR)

(72) Inventors: Yeon-Jung KIM, Gyeonggi-do (KR); Yoon-Jeong CHOI, Seoul (KR)

(73) Assignee: Samsung Electronics Co., Ltd., Gyeonggi-do (KR)

(21) Appl. No.: 14/048,367

(22) Filed: Oct. 8, 2013

(30) Foreign Application Priority Data
Oct. 9, 2012 (KR) 10-2012-0111865

(51) Int. Cl. G06F 3/0481

(52) U.S. Cl. CPC G06F 3/04817
USPC 715/846

(57) ABSTRACT

An electronic device and method for creating a virtual folder and managing stored applications capable of displaying a list of at least one application associated with a selected virtual folder based on metadata information of an application. A method of an electronic device can include receiving a touch input of any one of at least one virtual folder, calling at least one application registered to the touch-input virtual folder, and displaying the called at least one application.

### CLAIM OF PRIORITY

This application claims priority under 35 U.S.C. §119(a) to a Korean Patent Application filed in the Korean Intellectual Property Office on Oct. 9, 2012 and assigned Serial No. 10-2012-0111865, the contents of which are herein incorporated by reference.

### BACKGROUND

1. Field of the Invention

The present disclosure relates to viewing files in an electronic device. More particularly, the present disclosure relates to a method for creating folders and managing stored applications.

2. Description of the Related Art

As the functionality of an electronic device continues to develop, a user can perform various functions by a single electronic device that previously required separate devices. Electronic devices can now executing functions associated with different applications stored in the single electronic device.

For example, the user can now download several applications such as games, news, videos, audios, public traffic and the like to the electronic device to obtain information that changes in real-time, or to utilize leisure time more efficiently.

However, as various applications are stored in an electronic device, a user may find it difficult to systematically manage many applications stored in the electronic device. For example, in the case where the user photographs an object by using an application that executes a camera function stored in the electronic device. In the aforementioned assumption, the user has to sift through and select any one application most suitable according to a subject or a surrounding environment and the like, from among many applications stored in the electronic device. More particularly, there is an inconvenience that the user has to manually search through and select an application for performing a camera function one by one from among many applications stored in the electronic device.

In conventional electronic devices, as there were many applications stored in the electronic device, a user had a difficulty in managing the applications stored in the electronic device. For example, assume that eight applications can be displayed on each screen of the electronic device, a total of forty applications have been stored on five screens in the electronic device, and there are three applications associated with “camera” from among the stored forty applications. In the aforementioned assumption, to execute the application associated with “camera”, the user had to scroll a total of five screens while searching the applications associated with “camera” one by one. Accordingly, there was an inconvenience that the user had to search the total of forty applications one by one to select a camera application suitable to the kind of a subject and a surrounding environment. Undoubtedly, a user's inconvenience increases if the number of applications stored in the electronic device increases. Accordingly, there is a need in the art for development of an electronic device for quickly providing information for a related application that a user desires to operate, and as the increase in the number of applications have been stored in the electronic device increases, this need for such development increases.

### SUMMARY

An aspect of the present invention is to substantially solve at least some of the above problems and/or disadvantages and to provide at least the advantages below. Accordingly, one aspect of the present invention provides an apparatus and method for displaying a list of at least one or more applications associated with a selected virtual folder based on metadata information of an application, thereby improving a user's convenience.

Another aspect of the present invention provides an apparatus and method that effectively manages a plurality of applications by introducing the concept of a virtual folder, so as to not require users to sift and/or sort through a plurality of stored applications through introduction of a virtual folder according to the present invention.

A further aspect of the present invention provides an apparatus and method capable efficiently managing the application without additional sorting work by providing device-controlled subsequent management of an application or applications received after creating a virtual folder, so that the device can modify the virtual folder to reflect the applications subsequently created or downloaded to the electronic device without requiring additional sorting work by the user.

The above aspects are achieved by providing an electronic device and method for creating a virtual folder and managing stored applications as discussed herein below.

According to one aspect of the present invention, a method of an electronic device includes receiving a touch input of any one of at least one virtual folder, calling at least one application registered to the touch-input virtual folder, and displaying the called at least one application.

The method may further include detecting that an application has been newly-received, determining whether the created application is an application registrable to the virtual folder, and, when determining that the created application is the application registrable to the virtual folder, determining whether at least one application having the same metadata as activity metadata of the received application has been stored in the electronic device.

The activity metadata may comprise, for example, metadata that includes at least one action information including operation information of an application, and at least one data information including mime type information of the application.

Determining whether the created application is an application registrable to the virtual folder may include, for example, extracting the activity metadata of the received application, and determining whether the same metadata as the extracted activity metadata of the created application is included in storage, such as, for example, a stored table.

The application registrable to the virtual folder may be an application whose same metadata as the extracted activity metadata of the created application is included in storage, such as, for example, a stored table.

The method may further include extracting by the electronic device an application type of the created application if it is determined that at least one application having the same metadata as the activity metadata of the created application has not been stored in the electronic device, and including and adding identification of the extracted application type to a list of application types.

The method may further include, for example, receiving an input for creation of a virtual folder, and, to register at least one application to the virtual folder to be created, displaying a list of application types including information about an application type of a stored at least one application, and receiving a selection of any one application type among the displayed list of application types.

The method may further include, for example, analyzing the selected application type, calling at least one application having the analyzed application type from among the stored at least one application, and registering the called at least one application to the virtual folder to be created.

The virtual folder to be created may include at least one or more application types.

The method may further include receiving a selection of any particular application from among the displayed at least one application, and executing the selected application.

According to another aspect of the present invention, an electronic device includes a touch screen and a processor unit. The touch screen receives a touch input of any one of at least one virtual folder, and displays at least one application. The processor unit calls at least one application registered to the touch-input virtual folder.

The processor unit, for example, may detect that an application has been received, and determine if the received application is an application registrable to the virtual folder, and, if it is determined that the received application is an application registrable to the virtual folder, determine whether at least one application having the same metadata as activity metadata of the created application has been stored in the electronic device.

The activity metadata may include at least one action information including operation information of an application, and at least one data information including mime type information of the application.

The processor unit may extract the activity metadata of the received application, and determine whether the same metadata as the extracted activity metadata of the created application is included in storage, such as, for example, a stored table.

The application registrable to the virtual folder may be an application whose same metadata as the extracted activity metadata of the received application is included in a stored table.

The processor unit may extract an application type of the created/downloaded application when the controller determines that at least one application having the same metadata as the activity metadata of the created application has not been stored in the electronic device, and further include a memory for including and storing an identification of the extracted application type in a list of application types.

The touch screen may receive an input for creation of a virtual folder and, in order to register at least one application to the virtual folder to be created, may display a list of application types including information about an application type of a stored at least one application, and may receive a selection of any one application type from among the displayed list of application types.

The device may further include a processor unit for analyzing the selected application type, calling at least one application having the analyzed application type from among the stored at least one application, and a memory or controlling a memory for registering the called at least one application to the virtual folder to be created.

The virtual folder to be created may include at least one application type.

The touch screen may receive a selection of any one application from among the displayed at least one application, and the processor unit may execute the selected application.

### BRIEF DESCRIPTION OF THE DRAWINGS

The above features and advantages of the present invention will become better appreciated by a person of ordinary skill in the art from the following detailed description when taken in conjunction with the accompanying drawings in which:

FIG. 1 is an illustration an electronic device for creating a virtual folder to manage stored applications according to an exemplary embodiment of the present invention;

FIGS. 2A and 2B are an illustrations after extracting an application type of an application newly received in an electronic device according to the present invention, including and storing the extracted application type in a list of application types according to an exemplary embodiment of the present invention;

FIGS. 3A, 3B and 3C are an illustrations of creating a new virtual folder and selecting the created virtual folder to execute any one of a displayed at least one application according to an exemplary embodiment of the present invention;

FIGS. 4A, 4B and 4C are illustrations of creating a new virtual folder and selecting the created virtual folder to execute any one of a displayed at least one application according to an exemplary embodiment of the present invention;

FIGS. 5A, 5B, 5C and 5D are illustrations after creating a virtual folder and selecting the virtual folder to call a received application according to an exemplary embodiment of the present invention;

FIGS. 6A, 6B, 6C and 6D are diagrams illustrating an exemplary embodiment of a virtual folder that performs a function of each merged folder, when two virtual folders according to the present invention are merged together;

FIG. 7 is a flowchart illustrating one exemplary operational sequence of an electronic device according to the present invention;

FIG. 8 is a block diagram illustrating a construction of an electronic device according to an exemplary embodiment of the present invention;

FIG. 9A is a flowchart illustrating a method of an electronic device for creating a virtual folder according to an exemplary embodiment of the present invention to manage stored applications; and

FIG. 9B is a diagram illustrating an apparatus diagram of an electronic device for creating a virtual folder according to an exemplary embodiment of the present invention to manage stored applications.

### DETAILED DESCRIPTION

Preferred embodiments of the present invention will be described herein below with reference to the accompanying drawings. In the following description, well-known functions or constructions may not be described in detail when doing so would obscure appreciation by a person of ordinary skill in the art of the subject matter of the invention with unnecessary detail of such well-known functions or constructions. In addition, the terms described herein below are defined considering functions in the present invention that can be different depending on user and operator's intention or practice. Therefore, the terms should be defined on the basis of the disclosure throughout this specification.

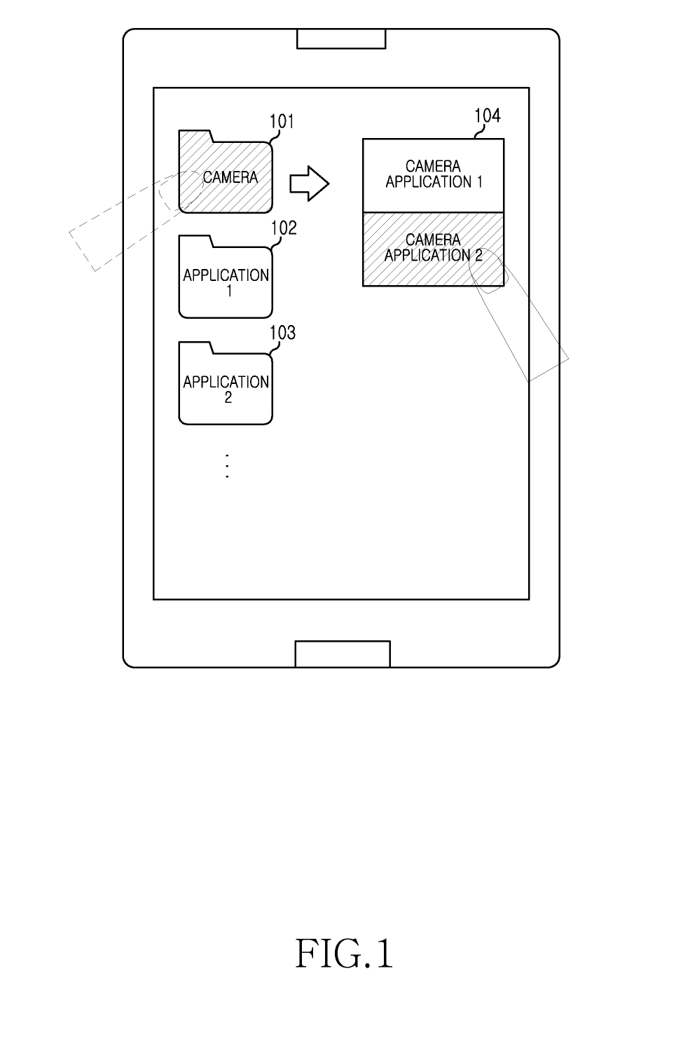

FIG. 1 is a diagram illustrating an electronic device for creating a virtual folder according to an exemplary embodiment of the present invention to manage stored applications. The electronic device according to the present invention can efficiently manage at least one or more applications stored in the electronic device by creating a virtual folder. Here, the virtual folder can be defined as a folder that does not store an application substantially in the folder but calling at least one application associated with the folder from among at least one application stored in the electronic device. In more detail, the virtual folder can be defined as a folder that when selected from a user, calls at least one application associated with the virtual folder from among at least one application stored in the electronic device.

First, the electronic device can determine whether an application newly created in/downloaded to the electronic device is an application registrable to the virtual folder. In more detail, after detecting by a controller that any application has been received, the electronic device can determine whether the created application is an application registrable to the virtual folder. In other words, after extracting activity metadata of the received application, the electronic device can determine if the same metadata as the extracted activity metadata of the received application is included in storage such as a table stored in the electronic device. Here, the table stored in the electronic device stores at least one application type and at least one activity metadata. In more detail, if detecting that a new application has been created in the electronic device, the a controller of electronic device can extract activity metadata information of the newly created application and then, compare the extracted activity metadata information of the newly created application with the stored table to determine whether the same metadata as the extracted activity metadata information of the newly created application is included in the stored table. In other words, the electronic device cannot register all applications created in the electronic device to a virtual folder but, after extracting activity metadata information of the newly created applications, the electronic device can register the extracted activity metadata information to the virtual folder, only when the extracted activity metadata information is the same as the metadata being in the table stored in the electronic device.

Here, the application type can be defined as, for example, a form of each application or a characteristic thereof. For example, an application type of an application for sharing a photo can be “photo sharing”, and an application type of an application for sharing a video can be “video sharing”, and an application type of an application for performing a camera function can be “camera”. Also, the activity metadata can be defined as metadata that includes at least one action information item and at least one data information item. In more detail, the activity metadata can be defined as metadata that includes at least one action information including operational information of an application and at least one data information including mime type information of the application. For example, activity metadata of an application associated with “browser” can be comprised of action information of “intent.ACTION_VIEW” and data information of “android:scheme=“http””. For another example, activity metadata of an application associated with “phone” can be comprised of action information of “android.intent.action.CALL” and data information of “android:scheme=“tell””.

If it is determined that an application newly created in/downloaded to the electronic device is an application registrable to a virtual folder, the electronic device can determine whether at least one application having the same metadata as activity metadata of the created application has been stored in the electronic device. In more detail, the electronic device extracts activity metadata information of the application newly created in/downloaded to the electronic device and then compares the extracted activity metadata information of the newly received application with metadata of a table stored in the electronic device. As a result of the aforementioned comparison result, if it is determined that the same metadata as the extracted activity metadata information of the newly created application has been stored in the table stored in the electronic device, the electronic device can determine whether at least one application having the same metadata as the activity metadata of the received application has been already stored in the electronic device. For example, assume that the application newly created in/downloaded to the electronic device is “application 1” associated with “phone”. In the aforementioned assumption, after the electronic device extracts activity metadata information from “application 1” and then determines that the extracted activity metadata information of “application 1” has been stored in the table of the electronic device, the electronic device can determine if the same activity metadata as the extracted activity metadata information of “application 1” has been stored in the table of the electronic device. More particularly, the electronic device can determine if the same activity metadata as activity metadata including action information of “android.intent.action.CALL” and data information of “android:scheme=“tell”” has been stored in the table of the electronic device.

If it is determined that at least one application having the same metadata as activity metadata of an application newly created in/downloaded to the electronic device has not been already stored in the electronic device, the electronic device can extract an application type of the created application and then, include and store the extracted application type in a list of application types. In the aforementioned example, if it is determined that at least one application having the same metadata as the activity metadata of the application associated with “phone” has not been stored in the electronic device, the electronic device can extract the application type “phone” of the newly created application and then, include and store the extracted application type “phone” in the list of application types.

As described above, if an application newly created in/downloaded to an electronic device is an application registrable to a virtual folder, the electronic device determines whether the same activity metadata as activity metadata of the newly created application has been stored in the table of the electronic device. If it is determined that the same activity metadata as the activity metadata of the newly created application has not been stored in the electronic device, the electronic device can extract an application type of the newly created application and then, include and store the extracted application type in a list of application types. After that, the electronic device can create a virtual folder, and store at least one application from among at least one application stored in the electronic device, in the virtual folder. In more detail, if receiving an input of creation of the virtual folder, the electronic device can display the list of application types including information about an application type of at least one application stored in the electronic device on a touch screen of the electronic device, and receive a selection of any one application type among the displayed list of application types.

For example, assuming that application types such as “phone”, “camera”, and “browser” have been stored in the list of application types in the electronic device, and the electronic device receives the input for creation of the virtual folder. In the aforementioned assumption, in order for the virtual folder to be created to receive a selection of an application type to be called, the electronic device can display the list of application types including the application types of “phone”, “camera”, and “browser” on the display screen or touch screen of the electronic device. Next, the electronic device can receive a selection of any one application type among the displayed list of three application types. For example, the electronic device can receive a selection of the application type “camera” displayed in the list of application types.

After receiving the selection of any particular application type included in the list of application types, the electronic device can analyze the selected application type, call at least one application having the analyzed application type from among a stored at least one application or applications, and register the called at least one application to the virtual folder to be created.

In the aforementioned example, if the electronic device receives a selection of the application type “camera”, the electronic device can call an application for performing a camera function from among at least one application stored in the electronic device, and register the called application to the virtual folder to be created. For example, assume that twenty applications have been stored in the electronic device and, from among the stored twenty applications, the applications associated with “camera” are known as “application 1” and “application 2”. In the aforementioned assumption, the electronic device can determine receipt of a selection of an application type “camera” from among the application types displayed on the touch screen and then, store in the virtual folder to be created the applications associated with “camera”, i.e., “application 1” and “application 2” from among, for example, twenty applications stored in the electronic device. Desirably, while registering the applications associated with “camera”, i.e., “application 1” and “application 2” to the virtual folder, the electronic device can set a title of the virtual folder by “camera”. More particularly, at the time of creating the virtual folder, the electronic device can set the application type of the registered application as the title of the virtual folder.

Next, if receiving a selection of any one of at least one virtual folder created in the electronic device, the electronic device can display, for example, at least one application registered to the selected virtual folder created in the electronic device. In more detail, the electronic device can receive a touch input of any one virtual folder from among at least one virtual folder, call at least one application registered to the touch-input virtual folder, and display the called at least one application.

For example, as illustrated in FIG. 1, assume in this case that forty applications (this is an arbitrary exemplary number and is not limiting the claimed invention to such an exemplary number) have been stored in the electronic device, and “application 1” 102 and “application 2” 103 have been registered to a virtual folder 101 created with a title of “camera”. In the aforementioned assumption, if it is sensed that the electronic device receives a touch input of the virtual folder 101 of “camera”, the electronic device can display a list 104 including two applications 102 and 103 registered to the virtual folder 101. After that, the electronic device can receive a selection of any one application from among the displayed at least one application, to execute the selected application. In the aforementioned example, the electronic device can display the list 104 including two applications 102 and 103 on the touch screen, and receive a selection of any one application from among two applications 102 and 103 to execute the selected application. In other words, if the electronic device receives a selection of “application 2” 103, the electronic device can execute the selected “application 2” 103.

Accordingly, the electronic device according to the present invention only selects a created virtual folder associated with “camera”, the electronic device can display at least one application for driving the camera, stored in the electronic device. After that, if the electronic device just receives only a selection of any one particular application from among the displayed at least one application, the electronic device can run the selected application automatically. In other words, in the electronic device according to the present invention, an application is registered to the created virtual folder, in order to permit managing of many applications effectively, without sorting each of applications stored in the electronic device.

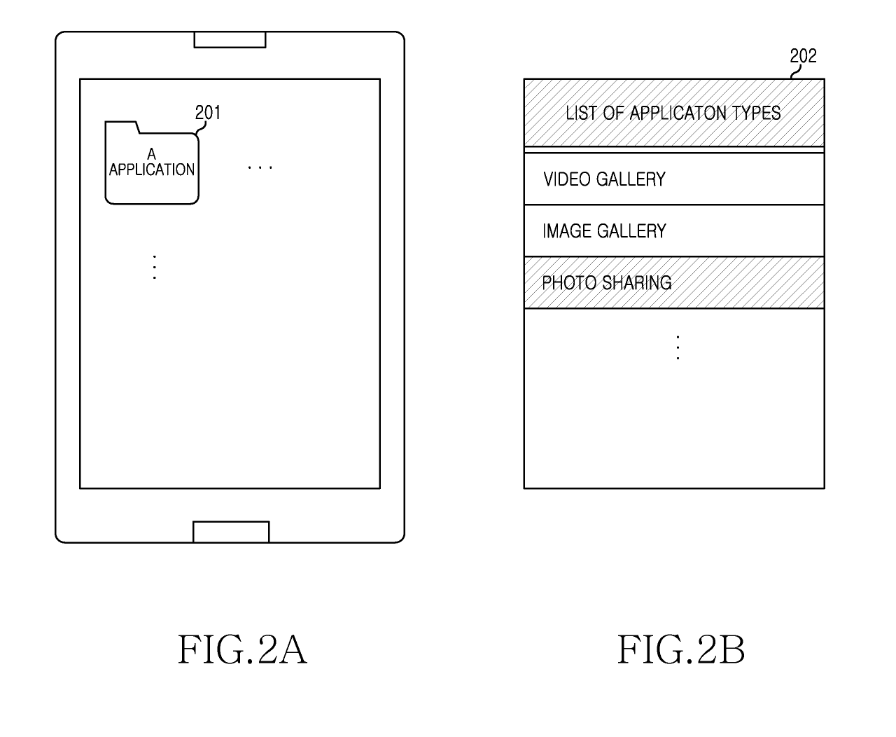

FIGS. 2A and 2B are diagrams illustrating an exemplary embodiment of, after extracting an application type of an application newly-received in an electronic device according to the present invention, including and storing the extracted application type in a list of application types. Table 1 represents an exemplary embodiment of a table stored in the electronic device according to the present invention.

TABLE 1

| | Activity metadata | |
|---|---|---|
| Application type | Action | Data |
| Photo sharing | android.intent.action.SEND | android.mimeType=“image/*” |
| Video sharing | android.intent.action.SEND | android.mimeType=“video/*” |
| Text sharing | android.intent.action.SEND | android.mimeType=“text/plain” |
| Phone | android.intent.action.CALL | android:scheme=“tell” |
| Browser | intent.ACTION_VIEW | android:scheme=“http” |
| Audio player | intent.ACTION_VIEW | android.mimeType=“audio/mp3” |
| Video player | intent.ACTION_VIEW | android.mimeType=“video/*” |
| Image gallery | intent.ACTION_GET_CONTENT | android.mimeType=“image/*” |
| Video gallery | intent.ACTION_GET_CONTENT | android.mimeType=“video/*” |

The electronic device according to the present invention can store a table including an application type and activity metadata information. As shown in Table 1, the table stored in the electronic device can store at least one application type, and can store the activity metadata information including action information and data information. For example, an application having a photo sharing function can have an application type “photo sharing”, and can have activity metadata that has action information of “android.intent.action.SEND” and data information of “android.mimeType=“image/*””. In the same meaning, an application having a browser function can have an application type “browser”, and can have activity metadata that has action information of “intent.ACTION_VIEW” and data information of “android:scheme=“http””.

First, the electronic device according to the present invention can determine whether an application newly created in/downloaded to the electronic device is an application registrable to the virtual folder. In more detail, after detecting that any application has been received, the electronic device can determine if the created application is an application registrable to the virtual folder. In other words, after extracting activity metadata of the created application, the electronic device can determine if the same metadata as the extracted activity metadata of the created application is included in a table stored in the electronic device. For example, assume that Table 1 has been stored in the electronic device, and the electronic device has extracted action information of “android.intent.action.SEND” and data information of “android.mimeType=“image/*”” as a result of extracting activity metadata information of the newly created application.

In the aforementioned assumption, the electronic device compares the action information and data information extracted from the newly received application with metadata information of the table stored in the electronic device. After that, the electronic device can determine whether the action information and data information of the newly received application are the same as the metadata information included in the table stored in the electronic device. More particularly, the electronic device can determine if the newly received application is an application which can be stored in a virtual folder. In conclusion, the electronic device cannot register all applications created in/downloaded to the electronic device to the virtual folder but, after extracting the activity metadata information of the newly received applications, the electronic device can register the extracted activity metadata information to the virtual folder, only when the extracted activity metadata information is the same as the metadata being in the table stored in the electronic device.

If it is determined that an application newly created in/downloaded to the electronic device is an application registrable to a virtual folder, the electronic device can determine if at least one application having the same metadata as activity metadata of the created application has been stored in the electronic device. In more detail, the electronic device extracts activity metadata information of the application newly created in/downloaded to the electronic device and then compares the extracted activity metadata information of the newly received application with metadata of a table stored in the electronic device. As a result of the comparison, if it is determined that the same metadata as the extracted activity metadata information of the newly received application has been stored in the table stored in the electronic device, the electronic device can determine whether at least one application having the same metadata as the activity metadata of the created application has been already-stored in the electronic device.

For example, assume that the application newly created in/downloaded to the electronic device is “application 1” associated with “audio player”. In the aforementioned assumption, after the electronic device extracts activity metadata information from “application 1” and then determines that the extracted activity metadata information of “application 1” has been stored in the table of the electronic device, the electronic device can determine whether the same activity metadata as the extracted activity metadata information of “application 1” has been stored in the electronic device. More particularly, the electronic device can determine if the same activity metadata as activity metadata including action information of “intent.ACTION_VIEW” and data information of “android mimeType=“audio/mp3”” stored in the table of the electronic device has been stored.

If it is determined that at least one application having the same metadata as activity metadata of an application newly created in/downloaded to the electronic device has not been already stored in the electronic device, the electronic device can extract an application type of the received application and then, include and store the extracted application type in a list of application types. In the aforementioned example, if it is determined that at least one application having the same metadata as the activity metadata of the application associated with “audio player” has not been already-stored in the electronic device, the electronic device can extract the application type “audio player” of the newly received application and then, include and store the extracted application type “audio player” in the list of application types.

For instance, as illustrated in FIG. 2A, assume that at least one application including ‘application A’ 201 has been stored in the electronic device. Also, as illustrated in FIG. 2B, assume that a video gallery and an image gallery have been stored in a list of application types 202 of the electronic device. In the aforementioned assumptions of FIGS. 2A and 2B, if it is determined that at least one application having the same metadata as activity metadata of a newly received application associated with “photo sharing” has not been stored in the electronic device, the electronic device can extract an application type “photo sharing” of the newly received application and then, include and store the extracted application type “photo sharing” in the list of application types 202.

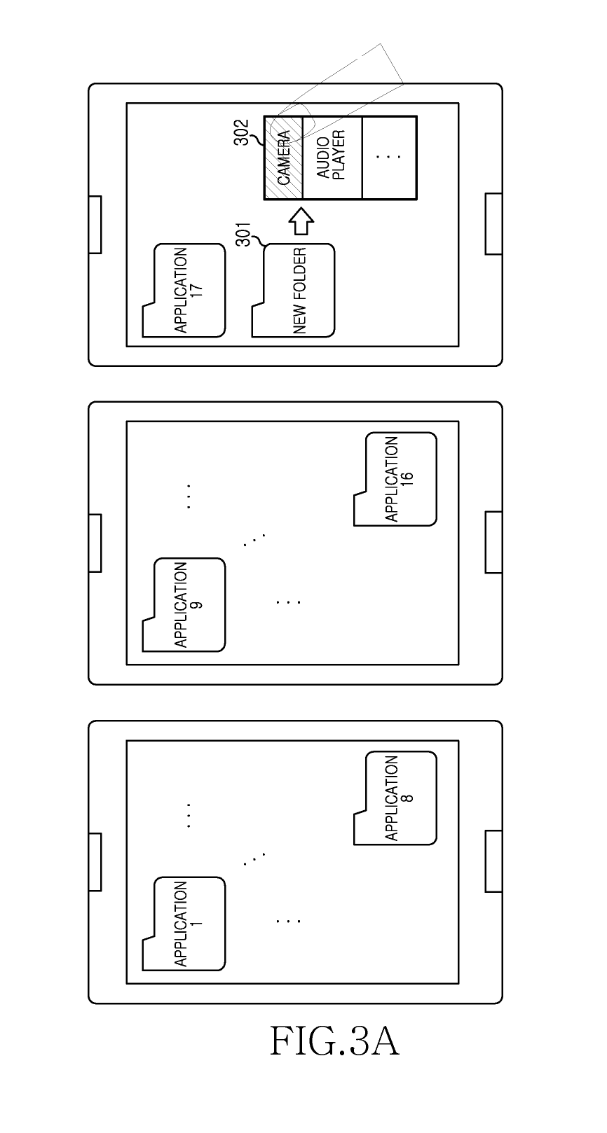

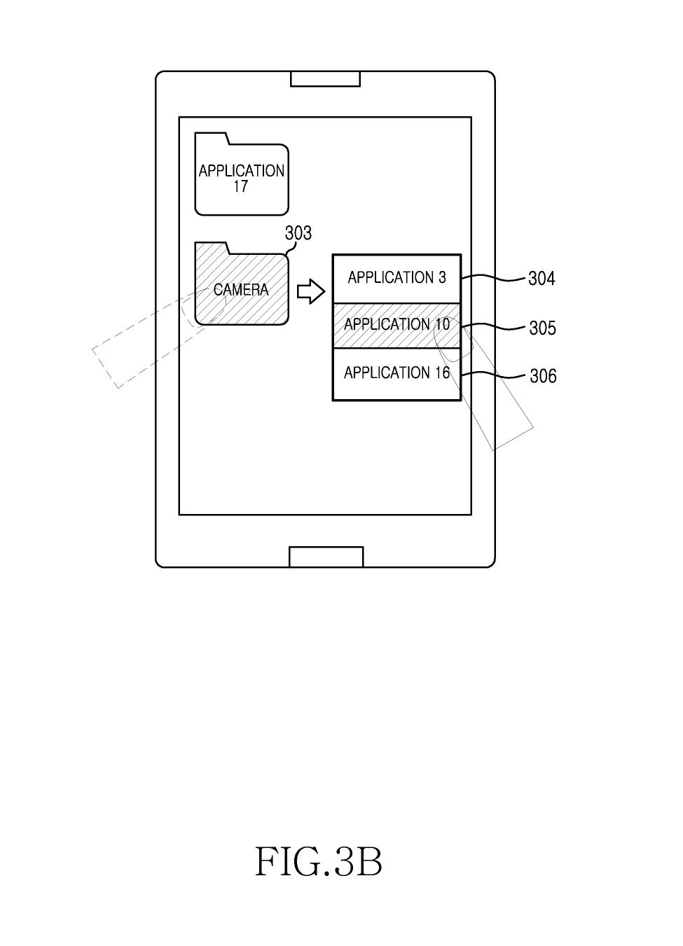

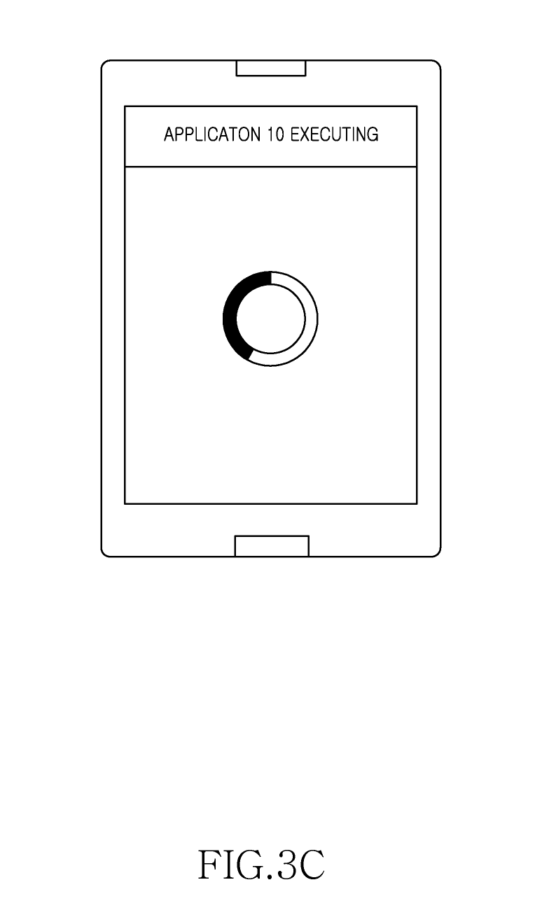

FIGS. 3A, 3B and 3C are diagrams illustrating an exemplary embodiment of creating a new virtual folder according to the present invention, and selecting the created virtual folder to execute any one of a displayed at least one application.

First, as illustrated in FIG. 3A, assume that a total of seventeen applications (i.e. an arbitrary plurality of applications for illustrative purposes) already have been stored in an electronic device, and a quantity of applications displayable on single screen of the electronic device are eight, respectively. Also, assume that applications associated with “camera” are total three from among the total of seventeen applications stored in the electronic device, and the total of seventeen applications have been already-stored in a list of application types such that they are suitable to a type of each application.

In the aforementioned assumption, the electronic device can receive an input for creating a virtual folder 301, and display on a touch screen a list 302 of application types including information about an application type of a stored at least one application so as to register at least one application to the virtual folder 301 to be created.

For example, if receiving the input of creation of the virtual folder 301, the electronic device can display on the touch screen the list 302 of application types including information about application types such as “photo sharing”, “video sharing”, “camera”, “audio player” and the like, so as to register at least one application to the virtual folder 301 to be created. If the electronic device senses that it receives a touch input representing a selection of any one application type displayed on the touch screen, the electronic device can register at least one application associated with the touch-input application type, to the virtual folder 301 to be created. For example, if the electronic device senses a selection of an application type associated with “camera” among the list 302 of application types displayed on the touch screen, the electronic device can store the selected three applications associated with “camera”, in the virtual folder 301 to be created.

Next, as illustrated in FIG. 3B, the electronic device can receive selection of a created virtual folder 303 to display at least one application 304, 305, and 306 registered to the virtual folder 303. In more detail, if the electronic device senses receiving a touch input of the created virtual folder 303, the electronic device can display at least one application 304, 305, and 306 registered to the virtual folder 303 on the touch screen of the electronic device. For example, if the electronic device senses receiving a selection of the virtual folder 303 created with a title of “camera”, the electronic device can display on the touch screen three applications 304, 305, and 306 registered to the virtual folder 303, from among the total of stored seventeen applications.

As illustrated in FIG. 3C, after displaying on the touch screen at least one application 304, 305, and 306 associated with the virtual folder 303, the electronic device can receive a selection of any one application among the displayed at least one application associated with the virtual folder 303, and execute the selected application. For example, if having received a selection of ‘application 10’ 305 from among three applications 304, 305, and 306 registered to the virtual folder 303 selected in the electronic device, the electronic device can execute the selected ‘application 10’ 305.

An advantage of the present invention over conventional electronic devices is that in a conventional electronic device, as there were many applications stored in the electronic device, a user had a difficulty in managing the applications stored in the electronic device. For example, assuming that eight applications can be displayed on each screen of the electronic device, and if a total of seventeen applications have been stored on three screens in the electronic device, and there are three applications associated with “camera” among the stored seventeen applications. In the aforementioned assumption, to execute the application associated with “camera”, the user had to scroll a total of three screens while searching for the three applications associated with “camera” one-by-one.

Accordingly, there was an inconvenience in conventional devices that the user had to search, for example, the total of seventeen applications one-by-one to select a camera application suitable to the kind of a subject and a surrounding environment. Undoubtedly, a user's inconvenience increases if the number of applications stored in the electronic device increases.

However, if the electronic device according to the present invention receives a selection of a created virtual folder 303 associated with “camera”, the electronic device can display at least one application for driving the camera, stored in the electronic device. After that, if the electronic device just only receive a selection of any one application among the displayed at least one application, the electronic device can run the selected application automatically. In the electronic device according to the present invention, if an application is registered to the created virtual folder, for managing many applications effectively, though not sorting through displays of each of the applications stored in the electronic device.

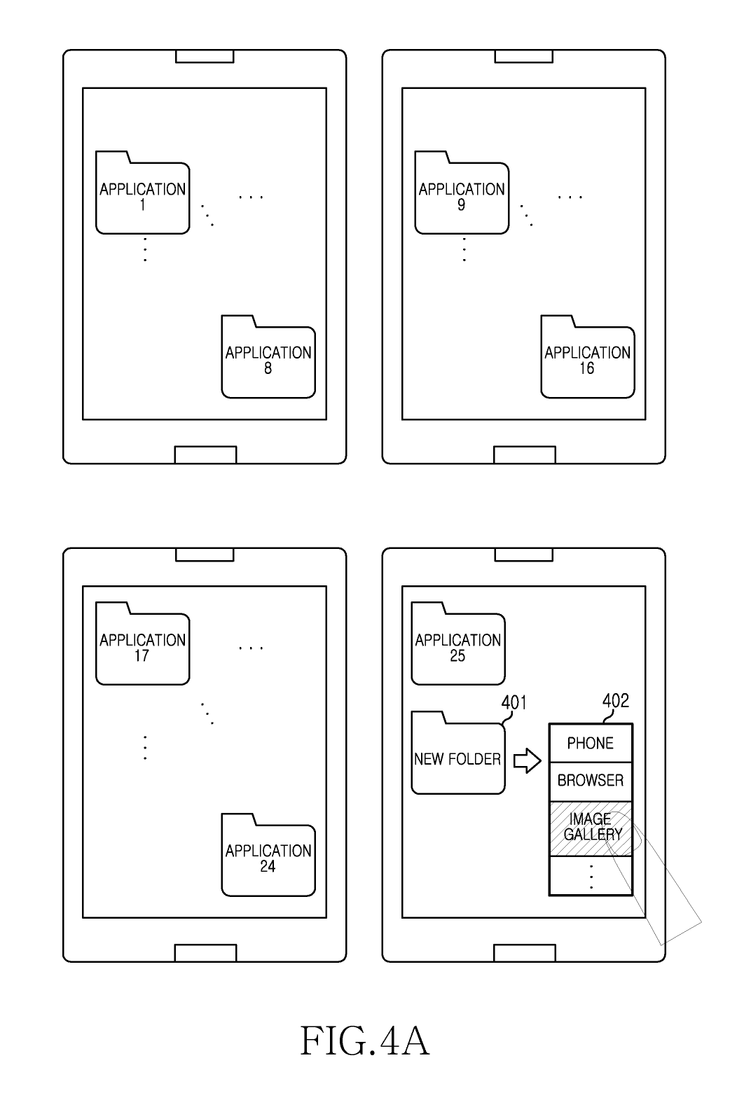

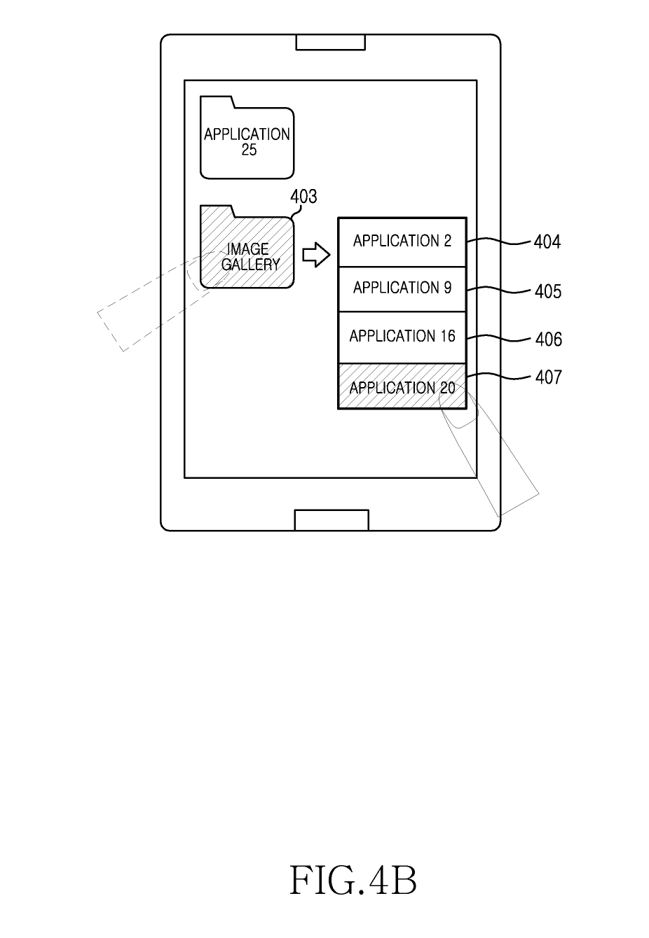

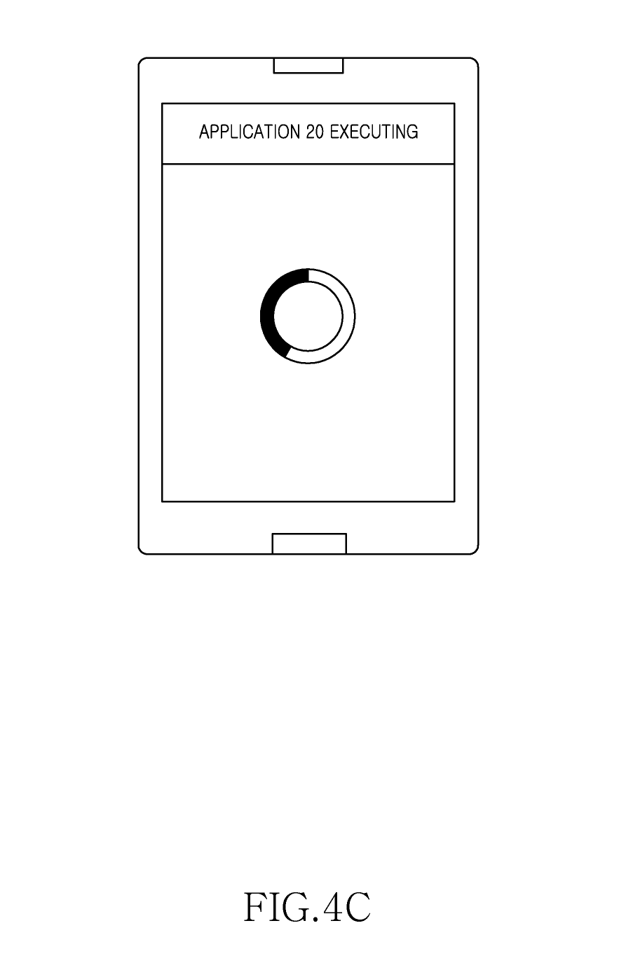

FIGS. 4A, 4B, 4C are diagrams illustrating another exemplary embodiment of creating a new virtual folder according to the present invention, and selecting the created virtual folder to execute any one of a displayed at least one application.

First, as illustrated in FIG. 4A, assuming that a total of twenty five applications (twenty five being an arbitrary non-limiting number provided for illustrative purposes) already have been stored in an electronic device, and applications displayable on one screen of the electronic device are eight, respectively. Also, assume that applications associated with “image gallery” are total four among the exemplary total of twenty five applications already stored in the electronic device, and the total of twenty five applications have been stored in a list of application types such that they are suitable to a type of each application.

In the aforementioned assumption, the electronic device can receive an input for creation of a virtual folder 401, and display on a touch screen a list 402 of application types including information about an application type of a stored at least one application so as to register at least one application to the virtual folder 401 to be created. For example, if receiving the input for creation of the virtual folder 401, the electronic device can display on the touch screen the list 402 of application types including information about application types such as “phone”, “browser”, “image gallery” and the like, so as to register at least one application to the virtual folder 401 to be created. If the electronic device senses receiving a touch input of any one application type displayed on the touch screen, the electronic device can register at least one application associated with the touch-input application type, to the virtual folder 401 to be created. For example, if the electronic device senses a selection of an application type associated with “image gallery” from among the list 402 of application types displayed on the touch screen, the electronic device can store the selected four applications associated with “image gallery”, in the virtual folder 401 to be created.

Next, as illustrated in FIG. 4B, the electronic device can select a created virtual folder 403 to display at least one application 404, 405, 406, and 407 registered to the virtual folder 403. In more detail, if the electronic device senses receiving a touch input of the created virtual folder 403, the electronic device can display at least one application 404, 405, 406, and 407 registered to the virtual folder 403 on the touch screen of the electronic device. For example, if the electronic device senses receiving a selection of the virtual folder 403 created with a title of “image gallery”, the electronic device can display on the touch screen four applications 404, 405, 406, and 407 registered to the virtual folder 403, from among the total of stored twenty five applications.

As illustrated in FIG. 4C, after displaying on the touch screen at least one application 404, 405, 406, and 407 associated with the virtual folder 403, the electronic device can receive a selection of any one application from among the displayed at least one application associated with the virtual folder 403, and execute the selected application.

For example, with reference to FIGS. 4B and 4C, if having received a selection of ‘application 20’ 407 from among four applications 404, 405, 406, and 407 registered to the virtual folder 403 selected in the electronic device, the electronic device can execute the selected ‘application 20’ 407.

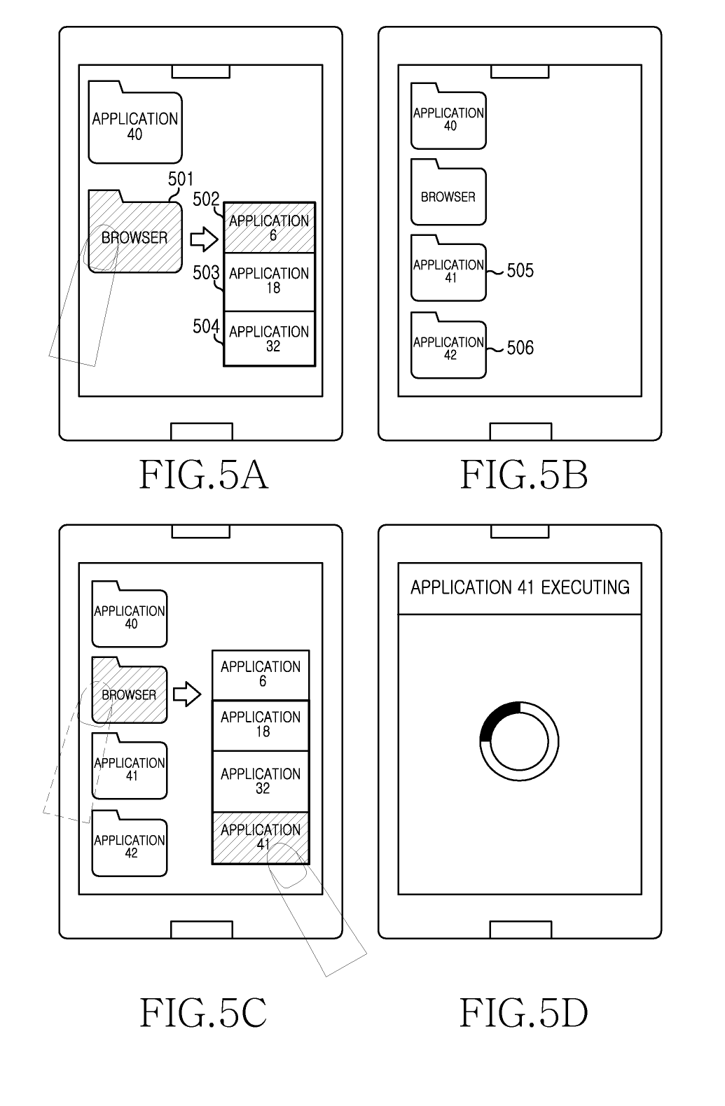

FIGS. 5A, 5B, 5C and 5D are diagrams illustrating an exemplary embodiment of, after creating a virtual folder according to the present invention, selecting the virtual folder to call a created application.

First, as illustrated in FIG. 5A, assume that a total of forty applications (forty being an arbitrary number for illustrative purposes) already have been stored in an electronic device, and a virtual folder 501 associated with “browser” has been created, and three applications of “application 6” 502, “application 18” 503, and “application 32” 504 have been registered to the created virtual folder 501. In other words, if receiving a touch input of the virtual folder 501 entitled “browser”, the electronic device can display on a touch screen three applications 502, 503, and 504 registered to the virtual folder 501, receive a selection of any one application from among the displayed three applications 502, 503, and 504, and execute the selected application.

After that, as illustrated in FIG. 5B, the electronic device can download two applications 505 and 506 from a server and display the downloaded applications 505 and 506 on the touch screen. In other words, after creating the virtual folder 501 associated with “browser”, the electronic device can newly create two applications 505 and 506. For example, assume that, from among two applications 505 and 506 newly created in the electronic device, “application 41” 505 is an application associated with “browser”, and “application 42” 506 is an application associated with “phone”. In the aforementioned assumption, the electronic device can determine that the newly created application is an application storable in a virtual folder. If it is determined that the application newly created in the electronic device is an application registrable to the virtual folder, the electronic device can determine if at least one application having the same metadata as activity metadata of the created application already has been stored in the electronic device. In more detail, the electronic device extracts activity metadata information of the application newly created in the electronic device and then compares the extracted activity metadata information of the newly received application with metadata of a table stored in the electronic device and, as the comparison result, if it is determined that the same metadata as the extracted activity metadata information of the newly received application already has been stored in the table stored in the electronic device, the electronic device can determine whether at least one application having the same metadata as the activity metadata of the created application has been already stored in the electronic device. In the aforementioned assumption, the electronic device can determine that, from among the applications newly created in the electronic device, “application 41” 505 is an application associated with “browser”, and three applications 502, 503, and 504 having the same metadata as that of “application 41” 505 have been already stored in the electronic device.

Next, as illustrated in FIG. 5C, if receiving a touch input of the virtual folder 501 entitled “browser”, the electronic device can display four applications 502, 503, 504, and 505 registered to “browser”, on the touch screen. In more detail, the electronic device can automatically register to the virtual folder 501 not only three applications 502, 503, and 504 associated with “browser” which are stored in the electronic device before creation of the virtual folder 501 entitled “browser” but also “application 41” 505 associated with “browser” which is newly stored in the electronic device after the creation of the virtual folder 501, and display the registered applications 502, 503, 504, and 505 on the touch screen. In other words, if an application associated with a created virtual folder among applications newly received after creation of the virtual folder, the electronic device according to the present invention automatically registers the application to the associated virtual folder. Accordingly, there is an advantage that, if a user creates any virtual folder, the electronic device automatically registers an application to be newly created in/downloaded to the electronic device to the virtual folder without needing to separately register the application to the virtual folder, improving a user's convenience.

As illustrated in FIG. 5D, after displaying on the touch screen at least one application associated with the virtual folder 501, the electronic device can receive a selection of any one application among the at least one application, and execute the selected application. For example, it is shown that, although just only having received a selection of “application 41” 505 newly created after creation of the virtual folder 501 from among the four applications 502, 503, 504, and 505 registered to the virtual folder 501, the electronic device can execute the selected “application 41” 505.

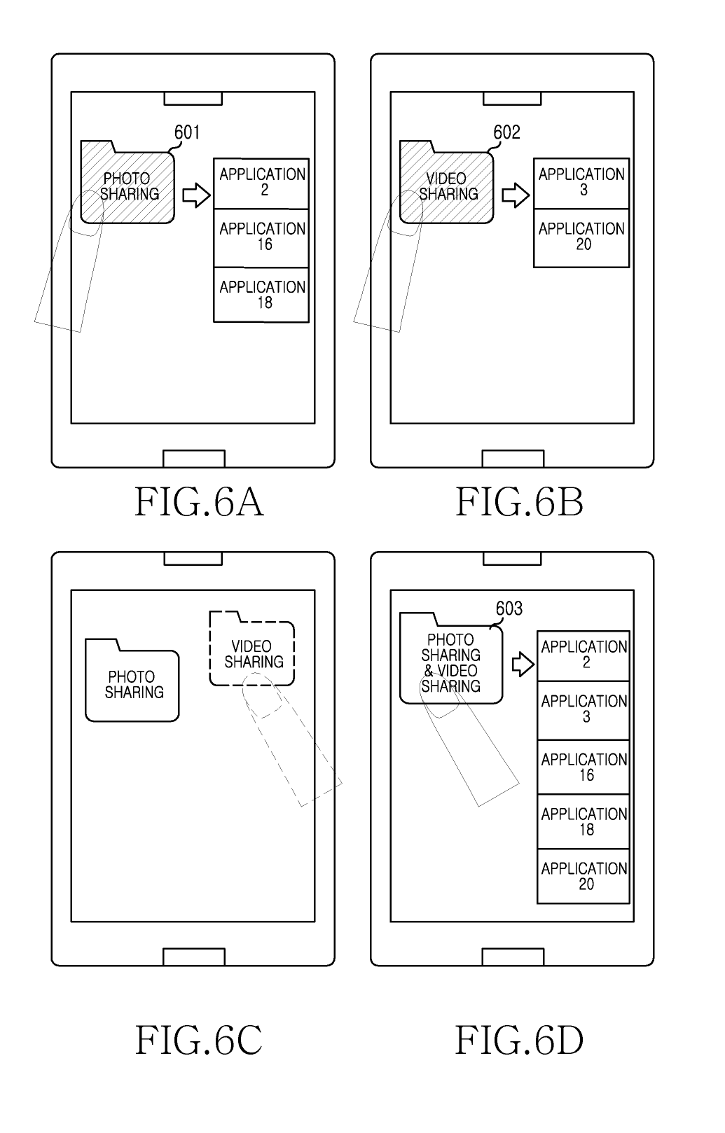

FIG. 6 is a diagram illustrating an exemplary embodiment of a virtual folder that can perform a function of each merged folder, when two virtual folders according to the present invention are merged together.

First, as illustrated in FIGS. 6A and 6B, a virtual folder 601 entitled “photo sharing” and a virtual folder 602 entitled “video sharing” have been created in an electronic device of this exemplary embodiment. In more detail, three applications of “application 2”, “application 16”, and “application 18” have been registered to the created virtual folder 601 entitled “photo sharing”. Also, two applications of “application 3” and “application 20” have been registered to the created virtual folder 602 entitled “video sharing”. In other words, if receiving a touch input of the virtual folder 601 entitled “photo sharing”, the electronic device can display on the touch screen three applications of “application 2”, “application 16”, and “application 18” associated with “photo sharing” among applications having been stored in the electronic device. Also, if receiving a touch input of the virtual folder 602 entitled “video sharing”, the electronic device can display on the touch screen two applications of “application 3” and “application 20” associated with “video sharing” from among the applications having been stored in the electronic device.

As illustrated in FIG. 6C, the electronic device according to the present invention can merge created virtual folders together. In more detail, the electronic device may merge created at least two virtual folders together. For example, the electronic device can drag the virtual folder entitled “video sharing” to the created virtual folder entitled “photo sharing” to create one virtual folder entitled “photo sharing & video sharing”. In other words, the electronic device according to the present invention may merge created at least two virtual folders into one folder according to need or, at the time of creating the first virtual folder, the electronic device may create the virtual folder performing two or more functions. For example, assume that, as a result that a user utilizes respective virtual folders each entitled “photo sharing” and “video sharing” after creating the virtual folders, there are many cases that, upon photo sharing, the photo sharing accompanies video sharing and, in contrast, there are many cases that, upon video sharing, the video sharing accompanies photo sharing. In the aforementioned assumption, the user can be aware of that it is not convenient to use the respective virtual folders separately and accordingly, so he/she merges two virtual folders into one virtual folder to create the virtual folder capable of performing two functions of “photo sharing” and “video sharing”, thereby making convenient use of a function of the virtual folder.

As illustrated in FIG. 6D, the electronic device can receive a touch input of a merged virtual folder 603, to call applications capable of performing respective functions of before merging and display the called applications on the touch screen. For example, assume that applications registered to the virtual folder entitled “photo sharing” are three applications of “application 2”, “application 16”, and “application 18”, and applications registered to the virtual folder entitled “video sharing” are two applications of “application 3” and “application 20”. In the aforementioned assumption, if receiving a touch input of the merged virtual folder 603, the electronic device can call three applications of “application 2”, “application 16”, and “application 18” capable of performing a photo sharing function and two applications of “application 3” and “application 20” capable of performing a video sharing function, and display the called applications of “application 2”, “application 3”, “application 16”, “application 18”, and “application 20” on the touch screen.

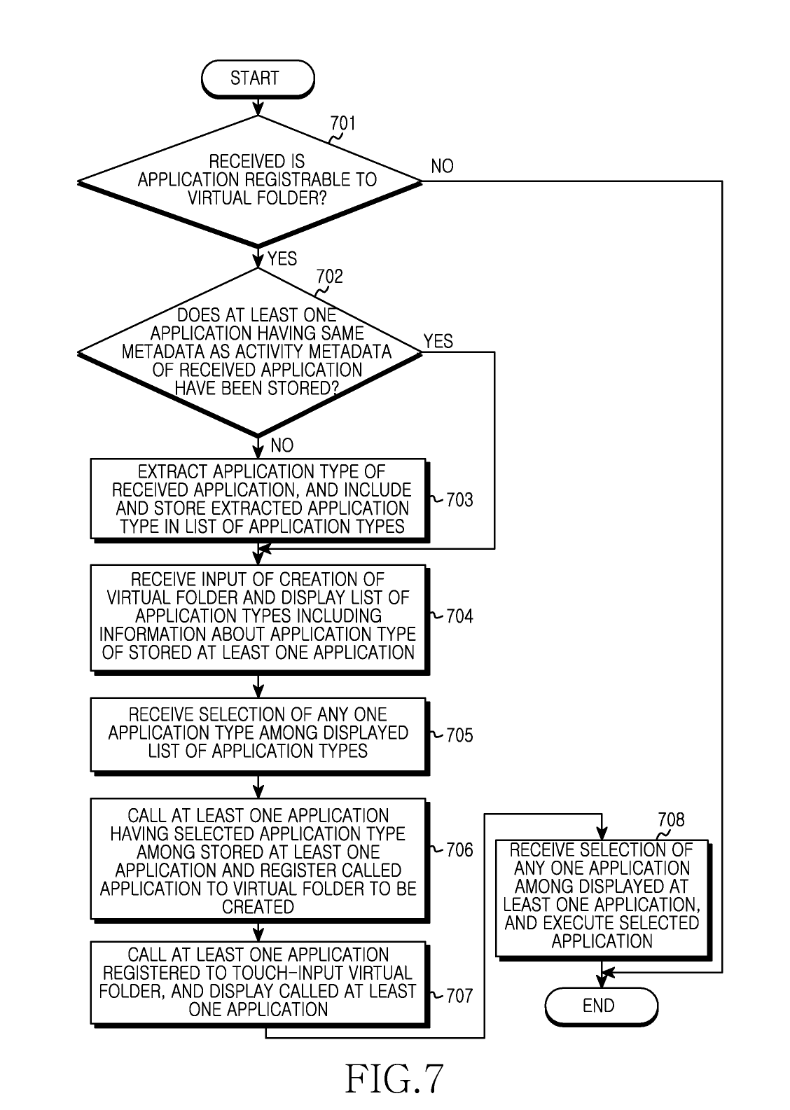

FIG. 7 is a flowchart illustrating an exemplary operational sequence of an electronic device according to the present invention.

As illustrated in FIG. 7, at (701) the electronic device can determine whether a received application is an application registrable to a virtual folder. In more detail, after detecting that any application has been newly-received, the electronic device can determine if the received application is the application registrable to the virtual folder. In other words, after extracting activity metadata of the received application, the electronic device can determine if the same metadata as the extracted activity metadata is included in a table stored in the electronic device. Here, at least one application type and at least one activity metadata have been stored in the table stored in the electronic device. In more detail, if detecting that a new application has been received in the electronic device, the electronic device can extract activity metadata information of the newly-received application and then, compare the extracted activity metadata information of the newly-received application with the stored table and determine if the same metadata as the extracted activity metadata information of the newly-received application is included in the stored table. That is, the electronic device cannot register all applications received in the electronic device to a virtual folder but, after extracting the activity metadata information of the newly-received applications, the electronic device can register the extracted activity metadata information to the virtual folder, only when the extracted activity metadata information is the same as the metadata being in the table stored in the electronic device.

If it is determined that an application newly-received in the electronic device is an application registrable to a virtual folder, then at (702) the electronic device can determine if at least one application having the same metadata as activity metadata of the received application has been stored in the electronic device. In more detail, the electronic device extracts activity metadata information of the application newly-received in the electronic device and then compares the extracted activity metadata information of the newly created application with metadata of a table stored in the electronic device and, as the comparison result, if it is determined that the same metadata as the extracted activity metadata information of the newly-received application has been stored in the table stored in the electronic device, the electronic device can determine whether at least one application having the same metadata as the activity metadata of the received application has been already stored in the electronic device. For example, assume that the application newly created in the electronic device is “application 1” associated with “phone”. In the aforementioned assumption, after the electronic device extracts activity metadata information from “application 1” and then determines that the extracted activity metadata information of “application 1” has been stored in storage, including but not limited to a table of the electronic device, the electronic device can determine if the same activity metadata as the extracted activity metadata information of “application 1” has been stored storage including but not limited to the table of the electronic device. In other words, the electronic device can determine if the same activity metadata as activity metadata including action information of “android.intent.action.CALL” and data information of “android:scheme=“tell”” stored in the table of the electronic device has been stored in storage, such as, for example, the table of the electronic device.

If it is determined that at least one application having the same metadata as activity metadata of an application newly-received in the electronic device has not been stored in the electronic device, then at (703) the electronic device can extract an application type of the received application and then, include and store the extracted application type in a list of application types. In the aforementioned example, if it is determined that at least one application having the same metadata as the activity metadata of the application associated with “phone” has not been stored in the electronic device, the electronic device can extract the application type “phone” of the newly-received application and then, include and store the extracted application type “phone” in the list of application types.

At (704), the electronic device can receive an input of creation of a virtual folder to display a list of application types including information about an application type of the stored at least one application. In more detail, if receiving the input of creation of the virtual folder, the electronic device can display, on a touch screen of the electronic device, the list of application types including the information about the application type of at least one application stored in the electronic device. For example, assume that application types of “phone”, “camera”, and “browser” have been stored in the list of application types stored in the electronic device, and the electronic device has received the input of creation of the virtual folder. In the aforementioned assumption, in order for the virtual folder to be created to receive an input of an application type to be called, the electronic device can display the list of application types including the application types of “phone”, “camera”, and “browser”, on the touch screen of the electronic device.

Next, at (705) the electronic device can receive a selection of any one application type from among the displayed list of application types. In the aforementioned example, the electronic device can receive a selection of any one application type after displaying the list of application types including the application types of “phone”, “camera”, and “browser” on the touch screen of the electronic device.

After receiving the selection of any one application type, at (706) the electronic device can call at least one application having the selected application type among the stored at least one application, and register the called at least one application to the virtual folder to be created. In the aforementioned example, if the electronic device receives the selection of the application type “camera”, the electronic device can call an application for performing a camera function among at least one application stored in the electronic device, and register the called application to the virtual folder to be created. In other words, assume that twenty applications (twenty is an arbitrary number selected for illustrative purposes only) have been stored in the electronic device and, among the stored twenty applications, applications associated with “camera” are “application 1” and “application 2”. In the aforementioned assumption, after the electronic device determines receiving a selection of the application type “camera” among the application types displayed on the touch screen, the electronic device can store in the virtual folder to be created the applications associated with “camera”, i.e., “application 1” and “application 2” among twenty applications stored in the electronic device. Desirably, while registering the applications associated with “camera”, i.e., “application 1” and “application 2” to the virtual folder, the electronic device can set a title of the virtual folder by “camera”. In other words, at the time of creating the virtual folder, the electronic device can set the application type of the registered application as the title of the virtual folder.

Next, at (707) the electronic device can call at least one application registered to the touch-input virtual folder to display the called at least one application. In more detail, the electronic device can receive a touch input of any one of at least one virtual folder to call at least one application registered to the touch-input virtual folder and display the called at least one application. For example, assume that forty applications have been stored in the electronic device, and “application 1” and “application 2” have been registered to a virtual folder created with a title of “camera”. In the aforementioned assumption, if the electronic device senses that it has received a touch input of the virtual folder entitled “camera”, the electronic device can display a list including two applications, i.e., “application 1” and “application 2” registered to the virtual folder entitled “camera”.

At (708), the electronic device can receive a selection of any one application among the displayed at least one application to execute the selected application. In the aforementioned example, the electronic device can display the list including two applications, i.e., “application 1” and “application 2” on the touch screen, and receive a selection of any one application from among two applications, i.e., “application 1” and “application 2” to execute the selected application. In other words, if the electronic device receives a selection of “application 2”, the electronic device can execute the selected “application 2”.

In the aforementioned determination process (702), if the device determines that at least one application having the same metadata as activity metadata of an application received in the electronic device has been stored in the electronic device, the electronic device jumps to step 704 and repeats the process of receiving an input of creation of a virtual folder and displaying a list of application types including information about an application type of a stored at least one application. Also, in (701), in the aforementioned determination process, if the electronic device determines that the application created in the electronic device is not the application registrable to the virtual folder, the electronic device just terminates the procedure according to the present invention.

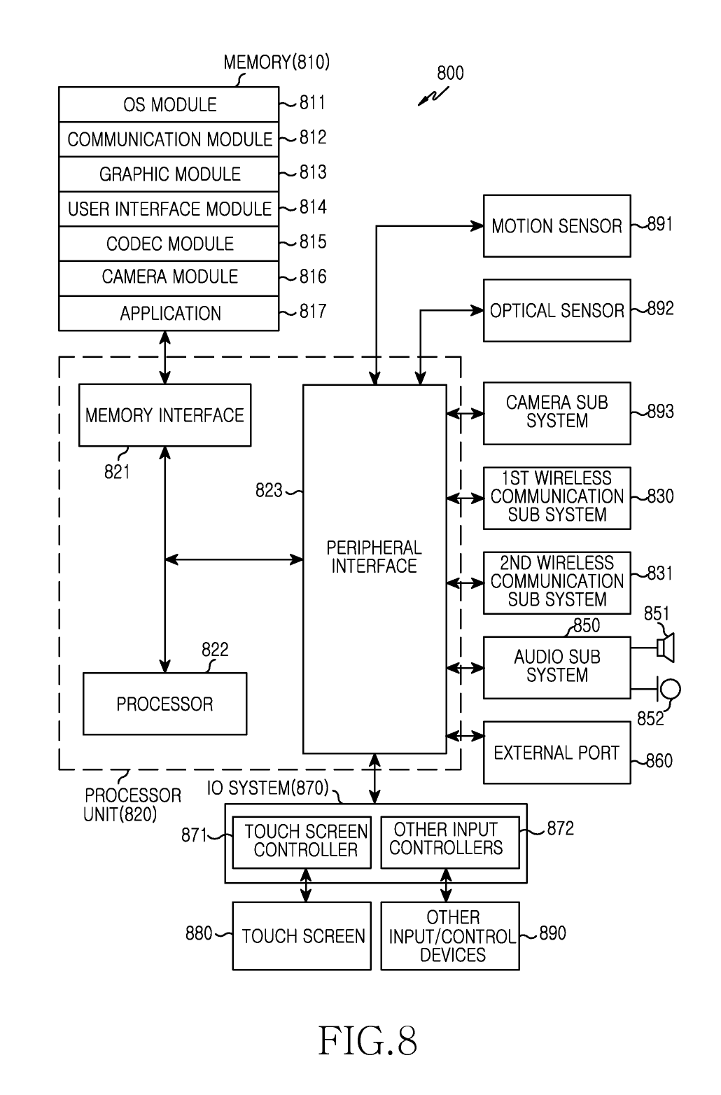

FIG. 8 is a block diagram illustrating a construction of an electronic device according to an exemplary embodiment of the present invention. This electronic device 800 can be a portable electronic device, and can be a device such as a portable terminal, a mobile phone, a mobile pad, a media player, a tablet computer, a handheld computer, phablet, or a Personal Digital Assistant (PDA), just to name some non-limiting possibilities. Also, the electronic device may be any portable electronic device including a device combining two or more functions among these devices.

The electronic device 800 includes in this example a non-transitory memory 810, a processor unit 820, a 1st wireless communication sub system 830, a 2nd wireless communication sub system 831, an audio sub system 850, a speaker 851, a microphone 852, an external port 860, an Input Output (IO) sub system 870, a touch screen 880, and other input or control devices 890. The memory 810 and the external port 860 can be used in plurality.

The processor unit 820, which includes circuitry such as a processor or microprocessor can include a memory interface 821, one or more processors 822 or sub-processors, and a peripheral interface 823. The entire processor unit 820 can also be referred to as a processor, or a controller or control unit. The processor unit 820 of the present invention calls at least one application registered to a touch-input virtual folder. In more detail, if sensing that the virtual folder is touch input, the processor unit 820 calls at least one application registered to the virtual folder. For example, in a case where “application 1” and “application 2” have been registered to the virtual folder, if sensing that the virtual folder is touch input, the processor unit 820 calls “application 1” and “application 2” stored in the virtual folder. Also, the processor unit 820 detects that any application has been created, and determines whether the received application is an application registrable to the virtual folder. If it is determined that the received application is the application registrable to the virtual folder, the processor unit 820 determines if at least one application having the same metadata as activity metadata of the received application has been stored in the electronic device. In more detail, the processor unit 820 can extract activity metadata information of the received application, determine if the extracted activity metadata information of the created application is the same as metadata stored in a table stored in the electronic device, and determine if the received application is the application registrable to the virtual folder. Also, if it is determined that the received application is the application registrable to the virtual folder, the processor unit 820 determines if at least one application having the same metadata as the activity metadata of the received application has been stored in the electronic device. For example, assume that an application newly-received in the electronic device is “application 1” associated with “phone”. In the aforementioned assumption, the processor unit 820 can extract activity metadata information from “application 1” and then, determine that the extracted activity metadata information of “application 1” has been stored in storage including but not limited to the storage table of the electronic device and then, determine whether the same activity metadata as the extracted activity metadata information of “application 1” has been stored in the storage table of the electronic device. Moreover, the processor unit 820 determines if the same activity metadata as action information of “android.intent.action.CALL” and data information of “android:scheme=“tell”” stored in the table of the electronic device has been stored in the table of the electronic device. Also, the processor unit 820 extracts the activity metadata of the received application, and determines if the same metadata as the extracted activity metadata is included in the stored table. Also, if it is determined that at least one application having the same metadata as the activity metadata of the received application has not been stored in the electronic device, the processor unit 820 extracts an application type of the received application. In the aforementioned example, if it is determined that at least one application having the same metadata as the activity metadata of a newly-received application associated with “phone” has not been stored in the electronic device, the processor unit 820 can extract an application type “phone” of the newly-received application and then, include and store the extracted application type “phone” in a list of application types. Also, the processor unit 820 analyzes a selected application type, calls at least one application having the analyzed application type among a stored at least one application, and executes the selected application.

The processor 822 can be configured to execute various software programs and performs various functions for the electronic device 800, and also performs processing and control for voice communication and data communication. Also, in addition to this general function, the processor 822 plays even a role of loading and executing machine readable code software module (i.e., an instruction set) stored in the memory 810 and performing specific various functions corresponding to the software module. That is, the processor 822, which comprises hardware, is loaded with machine executable code from the software modules stored in the memory 810 and the processor functions to perform a method of an exemplary embodiment of the present invention.

The processor 822 can include additional circuitry such as one or more data processors, image processors, or COder/DECoders (CODECs). The data processor, the image processor, or the CODEC may be constructed separately. Also, the processor 822 may be composed of several processors or sub-processor performing different functions. The peripheral interface 823 connects the IO sub system 870 of the electronic device 800 and various peripheral devices thereof to the processor 822 and to the memory 810 through the memory interface 821.

Various constituent elements of the electronic device 800 can be coupled with one another by one or more communication buses (not denoted by reference numerals) or stream lines (not denoted by reference numerals).

The external port 860 is used for direct connecting a portable electronic device (not shown) to other electronic devices or indirect connecting the portable electronic device (not shown) to other electronic devices over a network (for example, the Internet, an intranet, a Wireless Local Area Network (WLAN) and the like). For example, the external port 860 refers to, although not limited to, a Universal Serial Bus (USB) port, a FIREWIRE port or the like.

A motion sensor 891 and an optical sensor 892 are coupled to the peripheral interface 823 and enable various functions. For instance, the motion sensor 891 and the optical sensor 892 can be coupled to the peripheral interface 823, to sense a motion of the electronic device 800, sense a charge transfer quantity, and sense a light from the exterior, respectively. In addition, other sensors such as a global positioning system, a temperature sensor, a biological sensor or the like can be coupled to the peripheral interface 823 to perform related functions.

A camera sub system 893 can perform a camera function such as photo and video clip recording.

The optical sensor 892 can use a Charged Coupled Device (CCD) device or Complementary Metal-Oxide Semiconductor (CMOS) device.

A communication function is performed through one or more wireless communication sub systems 830 and 831. The 1st wireless communication sub system 830 and the 2nd wireless communication sub system 831 include hardware such as a receiver and transmitter, or transceiver. The receiver and transmitter may include a radio frequency (RF) receiver and transceiver and/or an optical (e.g., infrared) receiver and transceiver. The 1st wireless communication sub system 830 and the 2nd wireless communication sub system 831 can be distinguished according to a communication network in which the electronic device 800 communicates. For example, the communication network can include a communication sub system designed to operate through, although not limited to, a Global System for Mobile Communication (GSM) network, an Enhanced Data GSM Environment (EDGE) network, a Code Division Multiple Access (CDMA) network, a Wireless-Code Division Multiple Access (W-CDMA) network, a Long Term Evolution (LTE) network, an Orthogonal Frequency Division Multiple Access (OFDMA) network, a Wireless Fidelity (Wi-Fi) network, a Wireless interoperability for Microwave Access (WiMAX) network, a Bluetooth network or/and the like. Other wireless protocols can also be used in addition to those discussed herein before.

The audio sub system 850 can be coupled to the speaker 851 and the microphone 852, and take charge of input and output of an audio stream such as voice recognition, voice replication, digital recording, and telephony function. That is, the audio sub system 850 communicates with a user through the speaker 851 and the microphone 852. The audio sub system 850 contains circuitry such as an audio processor, which may be embodied as an integrated circuit, and receives a data stream through the peripheral interface 823 of the processor unit 820, converts the received data stream into an electric stream, and forwards the converted electric stream (i.e., electric signal) to the speaker 851. The speaker 851 converts the electric stream into human-audible sound waves to output the converted sound waves. The microphone 852 converts sound waves forwarded from human or other sound sources into electric streams. Also, the microphone 852 operates when any one of at least two or more 2nd sensors senses that an object is located within a set distance. The audio sub system 850 receives the converted electric streams from the microphone 852. The audio sub system 850 converts the received electric streams into audio data streams, and transmits the converted audio data streams to the peripheral interface 823. The audio sub system 850 can include a detachable earphone, headphone or headset.

The IO sub system 870 includes a touch screen controller 871 and/or other input controller 872. The touch screen controller 871 can be coupled to the touch screen 880. By using, though not limited to, capacitive, resistive, infrared and surface acoustic wave technologies for determining one or more contact points with the touch screen 880 as well as any multi-touch sensing technology including other proximity sensor arrays or other elements, the touch screen 880 and the touch screen controller 871 can detect a contact and a motion or an interruption thereof. The other input controller 872 can be coupled to the other input/control devices 890. The other input/control devices 890 can be one or more buttons, a rocker switch, a thumb-wheel, a dial, a stick, a pointer device such as a stylus and/or the like.

The touch screen 880 provides an input/output interface between the electronic device 800 and a user. In other words, the touch screen 880 forwards a user's touch input to the electronic device 800. Also, the touch screen 880 is a medium for showing an output of the electronic device 800 to the user. Moreover, the touch screen 880 shows a visual output to the user. This visual output can be presented in a form of a text, a graphic, a video, and a combination thereof.

The touch screen 880 can use various displays. For example, the touch screen 880 can use, though not limited to, a Liquid Crystal Display (LCD), a Light Emitting Diode (LED), a Light emitting Polymer Display (LPD), an Organic Light Emitting Diode (OLED), an Active Matrix Organic Light Emitting Diode (AMOLED), or a Flexible LED (FLED). The touch screen 880 of the present invention receives a touch input of any one of at least virtual folder, and displays a called at least one application. Also, the touch screen 880 receives an input of creation of a virtual folder and, in order to register at least one application in the virtual folder to be created, the touch screen 880 displays a list of application types including information about an application type of a stored at least one application, and receives a selection of any one application type among the displayed list of application types. Also, the touch screen 880 receives a selection of any one application from among the displayed at least one application.

The memory 810 can be coupled to the memory interface 821. The memory 810 can include high-speed random access memory and/or non-volatile memory such as one or more magnetic disk storage devices, one or more optical storage devices, and/or flash memory (for example, Not AND (NAND) memories, Not OR (NOR) memories).

The memory 810 can also stores machine executable code. A constituent element of the software includes an Operating System (OS) module 811, a communication module 812, a graphic module 813, a user interface module 814, a CODEC module 815, a camera module 816, one or more application modules 817 and the like. The OS software 811, for example, a built-in operating system such as WINDOWS, LINUX, Darwin, RTXC, UNIX, OS X, or VxWorks, includes machine executable code controlling general system operation. Control of the general system operation means, for example, memory management and control, storage hardware (device) control and management, power control and management and the like. The memory 810 of the present invention includes and stores an extracted application type in a list of application types, and registers a called at least one application to a virtual folder to be created.

The communication module 812, which contains circuitry that can enable communication with other electronic device such as a personal computer, a server, a portable terminal and/or the like, through the 1st and 2nd wireless communication sub systems 830 and 831 or the external port 860.

The graphic module 813 includes machine executable code machine executable code that is loaded into hardware such as a graphics processor, processor, microprocessor or controller for providing and displaying a graphic on the touch screen 880. The term ‘graphic’ is used as meaning including a text, a web page, an icon, a digital image, a video, an animation and the like.

The user interface module 814 includes machine executable code associated with a user interface. The user interface module 814 includes information about how a state of the user interface is changed and in which conditions the change of the state of the user interface is carried out, and the like.

The CODEC module 815 circuitry such as a coder and decoder can include machine executable code loaded in to hardware and executed for encoding of a video file and decoding thereof. The CODEC module 815 can include a video stream module such as an MPEG module and/or H204 module. Also, the CODEC module 815 can include various audio file CODEC modules such as AAA, AMR, WMA and the like. Also, the CODEC module 815 includes an instruction set corresponding to an embodiment method of the present invention.

The camera module 816 includes a camera related machine executable code that is executed by circuitry such as a processor, microprocessor and providing camera-related processes and functions.

The application module 817, for example includes a browser, an electronic mail (e-mail), an instant message, word processing, keyboard emulation, an address book, a touch list, a widget, Digital Right Management (DRM), voice recognition, voice replication, a position determining function, a location-based service and the like. The application module 817 is also associated with circuitry that executes machine executable code for providing functions and processes.

Also, various functions of the electronic device 800 according to the present invention mentioned above and to be mentioned below can be executed by hardware in the form of one or more stream processing and/or Application Specific Integrated Circuits (ASICs), and/or software, and/or a combination of them.

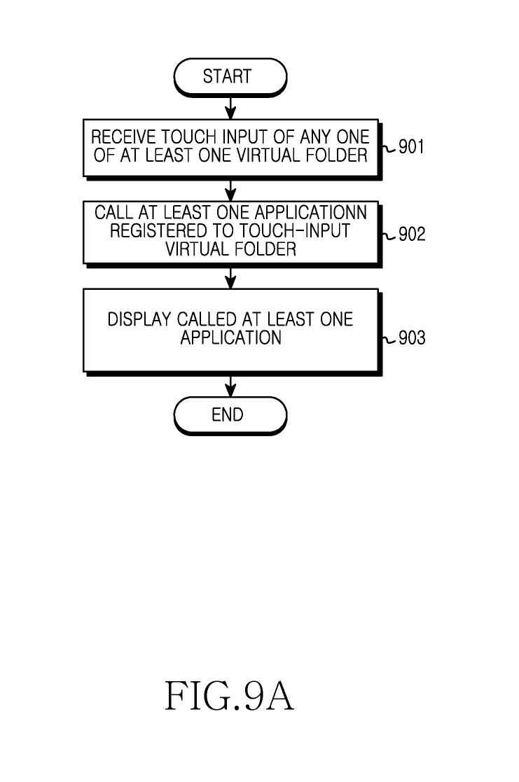

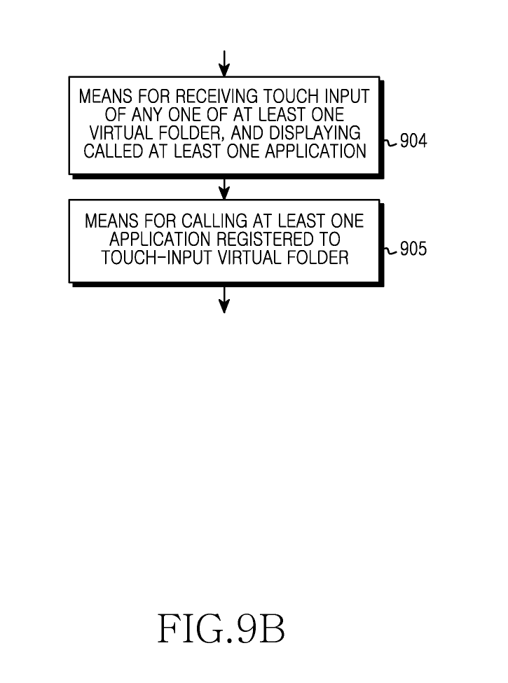

FIG. 9A is a flowchart illustrating a method of an electronic device for creating a virtual folder according to an exemplary embodiment of the present invention to manage stored applications.

First, at (901), the electronic device can receive a touch input of any one of at least one virtual folder. For example, assume that application types of “phone”, “camera”, and “browser” have been stored in a list of application types stored in the electronic device, and the electronic device has received an input of creation of a virtual folder. In the aforementioned assumption, the electronic device can display the list of application types including the application types of “phone”, “camera”, and “browser”, on a touch screen of the electronic device and then, receive a selection of any one application type.

At (902), the electronic device can call at least one application registered to the touch-input virtual folder. In the aforementioned example, if the electronic device receives a selection of the application type “camera”, the electronic device can call an application capable of performing a camera function among at least one application stored in the electronic device, and register the called application to the virtual folder to be created. In other words, assuming that twenty applications (arbitrary non-limiting number provided for illustrative purposes only) have been stored in the electronic device and, among the stored twenty applications, applications associated with “camera” are “application 1” and “application 2”. In the aforementioned assumption, after the electronic device determines that it receives a selection of the application type “camera” among the application types displayed on the touch screen, the electronic device can store in the virtual folder to be created the applications associated with “camera”, i.e., “application 1” and “application 2” from among twenty applications stored in the electronic device. Desirably, while registering the applications associated with “camera”, i.e., “application 1” and “application 2” to the virtual folder, the electronic device can set a title of the virtual folder by “camera”. In other words, at the time of creating the virtual folder, the electronic device can set the application type of the registered application as the title of the virtual folder.

At (903), the electronic device can display the called at least one application. In more detail, the electronic device can receive a touch input of any one of at least one virtual folder to call at least one application registered to the touch-input virtual folder and display the called at least one application. For example, assume that forty applications have been stored in the electronic device, and “application 1” and “application 2” have been registered to a virtual folder created with a title of “camera”. In the aforementioned assumption, if the electronic device senses receiving a touch input of the virtual folder entitled “camera”, the electronic device can display a list including two applications, i.e., “application 1” and “application 2” registered to the virtual folder entitled “camera”. Next, the electronic device can receive a selection of any one application from among the displayed at least one application to execute the selected application. In the aforementioned example, the electronic device can display the list including two applications, i.e., “application 1” and “application 2” on the touch screen, and receive a selection of any one application among two applications, i.e., “application 1” and “application 2” to execute the selected application. That is, if the electronic device receives a selection of “application 2”, the electronic device can execute the selected “application 2”.

FIG. 9B is a diagram illustrating an apparatus diagram of an electronic device capable of creating a virtual folder according to an exemplary embodiment of the present invention to manage stored applications.

At (904), a touch screen of an electronic device can receive a touch input of any one of at least one virtual folder, and display a called at least one application. For example, assume that four virtual folders of “phone”, “camera”, “audio player”, and “video gallery” have been displayed on the touch screen of the electronic device, and “application 1” and “application 2” capable of driving a camera have been stored in the virtual folder of “camera”. In the aforementioned example, the touch screen of the electronic device can receive a touch input of the virtual folder of “camera” among the displayed four virtual folders of “phone”, “camera”, “audio player”, and “video gallery”. After that, the touch screen of the electronic device can display the called “application 1” and “application 2”. Here, the touch screen can use various displays. For example, the touch screen can use, although not limited to, an LCD, an LED, an LPD, an OLED, an AMOLED, or a FLED.

At (905), a processor unit of the electronic device can call at least one application registered to the touch-input virtual folder. In the aforementioned example, the processor unit of the electronic device can call applications associated with “camera”, i.e., “application 1” and “application 2” registered to the touch-input virtual folder of “camera” among the four virtual folders of “phone”, “camera”, “audio player”, and “video gallery” displayed on the touch screen. Here, the processor unit can include various circuitry, such as a memory interface, one or more processors, and peripheral interfaces.

According to an electronic device and method for creating a virtual folder of the present invention to manage stored applications, there is an effect of, by introducing the concept of the virtual folder, of effectively managing the applications though eliminating the need to sort through a plurality of stored applications, and automatically grouping applications in virtual files based on an attribute detected by a processor of the electronic device when compared with applications of various types in storage.

Accordingly, when an electronic device according to the present invention selects a created virtual folder associated with “camera”, the electronic device can display at least one application for driving the camera, stored in the electronic device. After that, if the electronic device just receives only a selection of any one particular application from among the displayed at least one application, the electronic device can run the selected application automatically. In other words, in the electronic device according to the present invention, an application is registered to the created virtual folder, in order to permit managing of many applications effectively, without sorting and sifting through each of applications stored in the electronic device.

The above-described apparatus and a method of operation according to the present invention can be implemented in hardware, and in part as firmware or as software or computer code that is stored on a non-transitory machine readable medium such as a CD ROM, a RAM, a floppy disk, a hard disk, or a magneto-optical disk or computer code downloaded over a network originally stored on a remote recording medium or a non-transitory machine readable medium and stored on a local non-transitory recording medium, so that the methods described herein are loaded into hardware such as a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. In addition, an artisan understands and appreciates that a “processor” or “microprocessor” constitute hardware in the claimed invention. Under the broadest reasonable interpretation, the appended claims constitute statutory subject matter in compliance with 35 U.S.C. §101. Further, any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”.

The terms “unit” or “module” as referred to herein is to be understood as constituting hardware such as a processor or microprocessor configured for a certain desired functionality, or a non-transitory medium comprising machine executable code, in accordance with statutory subject matter under 35 U.S.C. §101 and does not constitute software per se.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An operation method of an electronic device, the method comprising:
receiving at a touch screen of at least one virtual folder;
calling by a processor at least one application registered to the selected virtual folder; and
displaying the called at least one application.

2. The method of claim 1, further comprising:
detecting by the processor when application has been received;
determining whether the received application is an application registrable to the virtual folder; and
when determining that the received application is the application registrable to the virtual folder, determining whether at least one application registered to the virtual folder having a same metadata as activity metadata of the received application has been already stored in the electronic device.

3. The method of claim 2, wherein the activity metadata is metadata that comprises at least one action information comprising operation information of an application, and at least one data information comprising mime type information of the application.

4. The method of claim 2, wherein determining whether the received application is the application registrable to the virtual folder comprises:
extracting the activity metadata of the received application; and
determining whether the same metadata as the extracted activity metadata of the received application is present in a storage.

5. The method of claim 2, wherein the application registrable to the virtual folder is an application whose same metadata as the extracted activity metadata of the received application is present in a storage.

6. The method of claim 2, further comprising:
when determining that at least one application having the same metadata as the activity metadata of the received application has not been stored in the electronic device, extracting an application type of the received application; and
comprising and storing the extracted application type in a list of application types

7. The method of claim 1, further comprising:
receiving an input requesting creation of a virtual folder;
displaying a list of application types comprising information about an application type of a stored at least one application to register at least one application to the virtual folder to be created; and
receiving a selection of any particular application type from among the displayed list of application types.

8. The method of claim 7, further comprising:
analyzing the selected application type;
calling at least one application having the analyzed application type from among the stored at least one application; and
registering the called at least one application to when the virtual folder is created.

9. The method of claim 7, wherein the virtual folder comprises at least one application type.

10. The method of claim 1, further comprising:
receiving a selection of any particular application from among the displayed at least one application; and
executing by the processor the selected application.

11. An electronic device comprising:
a touch screen for receiving a touch input selection of at least one virtual folder, and displaying at least one application; and
a processor unit for calling at least one application registered to the touch-input virtual folder.

12. The device of claim 11, wherein the processor unit detects that a particular application has been received, and determines whether the received application is an application registrable to the virtual folder, and, when the received application is the application registrable to the virtual folder, determines whether at least one application having the same metadata as activity metadata of the received application already has been stored in the electronic device.

13. The device of claim 12, wherein the activity metadata is metadata that comprises at least one action information comprising operation information of an application, and at least one data information comprising mime type information of the application.

14. The device of claim 12, wherein the processor unit extracts the activity metadata of the received application, and determines whether the same metadata as the extracted activity metadata of the received application is stored in storage.

15. The device of claim 12, wherein the application registrable to the virtual folder is an application whose same metadata as the extracted activity metadata of the received application is stored in storage.

16. The device of claim 12, wherein when the processor unit extracts an application type of the received application, the processor unit determines whether at least one application having the same metadata as the activity metadata of the received application has not been stored in the electronic device, and
further comprising a memory for comprising and storing the extracted application type in a list of application types.

17. The device of claim 11, wherein the touch screen receives an input requesting creation of a virtual folder and, to register at least one application to the virtual folder requested to be created, and the touch screen displays a list of application types comprising information about an application type of a stored at least one application in storage, and receives a selection of any particular application type from among the displayed list of application types.

18. The device of claim 17, further comprising:
a processor unit for analyzing the selected application type, calling at least one application having the analyzed application type from among the stored at least one application in storage; and
a memory for registering the called at least one application to the virtual folder to be created.

19. The device of claim 17, wherein the virtual folder to be created comprises at least one application type.

20. The device of claim 11, wherein the at least one application comprises a plurality of applications, and the touch screen receives a selection of any particular application from among the plurality of applications displayed, and
the processor unit executes the selected application.
